(19) United States
(12) Patent Application Publication
(10) Pub. No.: US 2016/0282796 A1
(43) Pub. Date: Sep. 29, 2016

(54) SHEET PROCESSOR AND IMAGE FORMING SYSTEM

(71) Applicant: KONICA MINOLTA, INC., Tokyo (JP)

(72) Inventor: Yu TANAKA, Yokohama-shi (JP)

(73) Assignee: KONICA MINOLTA, INC., Tokyo (JP)

(21) Appl. No.: 15/064,561

(22) Filed: Mar. 8, 2016

(30) Foreign Application Priority Data
Mar. 26, 2015 (JP) 2015-064412

(51) Int. Cl. G03G 15/00; B65H 37/00; B65H 43/00; B65H 29/12

(52) U.S. Cl. CPC G03G 15/6582; B65H 29/125; B65H 37/00; B65H 43/00; B65H 2406/20; B65H 2515/716

(57) ABSTRACT

A sheet processor includes at least one moisturizing roller, at least one water feeding roller, at least one water remover and a controller. The at least one moisturizing roller moisturizes a sheet. The at least one water feeding roller feeds water to a circumferential surface of the moisturizing roller. The at least one water remover is disposed in the vicinity of the water feeding roller and adjusts the volume of the water retained on a circumferential surface of the water feeding roller. The controller controls a distance between the water feeding roller and the water remover.

### BACKGROUND OF THE INVENTION

1. Field of the Invention

The present invention relates to a sheet processor and an image forming system.

2. Description of Related Art

In image forming devices, stacked sheets may stick to each other or repel and separate from each other due to electrical charging of the sheets through a transfer voltage or a static charge generated during conveying.

This can be prevented through moisturizing of the sheets with a moisturizer, to promote flow of the electric charges in the sheets.

The moisturizer, for example, includes a pair of moisturizing rollers that hold water on their circumferential surfaces and water feeding rollers that feed water to the moisturizing rollers. The moisturizing rollers apply water to the entire face of a sheet while conveying the sheet therebetween. The water feeding rollers absorb water and retain films of water on their surfaces. The sum of the water absorbed and the films of water can be fed to the moisturizing rollers.

For moisturizing with a sheet processor including such a moisturizer, coated paper, for example, has low permeability to water compared to uncoated paper and thus should be moisturized with a large volume of water to achieve a sufficient flow of electric charges. In contrast, excessively moisturized uncoated paper cannot be readily conveyed and may cause jamming.

Thus, the volume of water to be applied to a sheet in such a sheet processor for neutralization should be adjusted depending on the condition of the sheet, including the type of paper, for example.

The volume of the water to be applied can be adjusted through several techniques, such as a variable nip pressure of the moisturizing rollers and water feeding rollers (for example, refer to Japanese Patent Application Laid-Open No. 2007-292914) and a variable rotational rate of the moisturizing rollers relative to the sheet-conveying rollers (for example, refer to Japanese Patent Application Laid-Open No. 2012-24953).

Unfortunately, the technique described in Japanese Patent Application Laid-Open No. 2007-292914 cannot achieve stable control of the moisture level for achieving desired neutralization because the moisturizing rollers and the water feeding rollers are pushed toward each other and cause removal of the films of water on the surfaces of the water feeding rollers and transfer of the water absorbed on the water feeding rollers to the moisturizing rollers.

In the configuration disclosed in Japanese Patent Application Laid-Open No. 2012-24953, a high moisture level can only be achieved through the slipping of the moisturizing rollers on the sheet. Unfortunately, this prevents stable control of the moisture level and may cause damage to the sheets.

### SUMMARY OF THE INVENTION

An object of the present invention, which has been conceived in light of the problems in the conventional art, is to provide a sheet processor and an image forming system that can stably control the moisture level and achieve desirable neutralization.

To achieve the above-described object, according to one aspect of the present invention, there is provided a sheet processor including; at least one moisturizing roller that moisturizes a sheet; at least one water feeding roller that feeds water to a circumferential surface of the moisturizing roller; at least one water remover that is disposed in the vicinity of the water feeding roller and adjusts the volume of the water retained on a circumferential surface of the water feeding roller; and a controller that controls the distance between the water feeding roller and the water remover.

Preferably, in the sheet processor, the at least one moisturizing roller includes one and another moisturizing rollers that have circumferential surfaces in contact with each other; the at least one water feeding roller includes one and another water feeding rollers respectively provided for the one and another moisturizing rollers; and the at least one water remover includes one and another water removers respectively provided for the one and another water feeding rollers, wherein the controller independently controls the distance between the one water feeding roller and the one water remover and the distance between the another water feeding roller and the another water remover.

According to one aspect of the present invention, there is provided a sheet processor including at least one moisturizing roller that moisturizes a sheet; at least one water feeding roller that feeds water to a circumferential surface of the moisturizing roller; at least one water remover that is disposed in the vicinity of the moisturizing roller and adjusts the volume of the water retained on the circumferential surface of the moisturizing roller; and a controller that controls the distance between the moisturizing roller and the water remover.

Preferably, in the sheet processor, the at least one moisturizing roller includes one and another moisturizing rollers that have circumferential surfaces in contact with each other; the at least one water feeding roller includes one and another water feeding rollers respectively provided for the one and another moisturizing rollers; and the at least one water remover includes one and another water removers respectively provided for the one and another moisturizing rollers, wherein the controller independently controls the distance between the one moisturizing roller and the one water remover and the distance between the another moisturizing roller and the another water remover.

Preferably, in the sheet processor, the one and another moisturizing rollers hold and convey the sheet.

Preferably, in the sheet processor, the controller controls the distance based on sheet conditions including a type and printing conditions of the sheet.

Preferably, in the sheet processor, the controller controls the distance based on an installation environment of the sheet processor and a quality of the water.

According to one aspect of the present invention, there is provided an image forming system, including an image forming device that forms an image on a sheet; and the sheet processor, the sheet processor being connected to the image forming device and moisturizing the sheet having an image formed by the image forming device.

### BRIEF DESCRIPTION OF THE DRAWINGS

The present invention will be described through the detailed description below and the accompanying drawings. Such description and drawings should not be construed to limit the present invention.

FIG. 1 illustrates the overall configuration of an image forming system;

FIG. 2 is a block diagram illustrating the essential components of an image forming device and a first sheet processor;

FIG. 3 is a schematic view illustrating the configuration of a moisturizer;

FIG. 4 is a schematic view illustrating a water remover of the moisturizer according to another embodiment;

FIG. 5 illustrates the advantages of the configuration of the moisturizer; and

FIG. 6 is a schematic view illustrating the configuration of the moisturizer according to a modification.

### DESCRIPTION OF THE PREFERRED EMBODIMENTS

A sheet processor and an image forming system according to embodiments of the present invention will now be described with reference to the accompanying drawings.

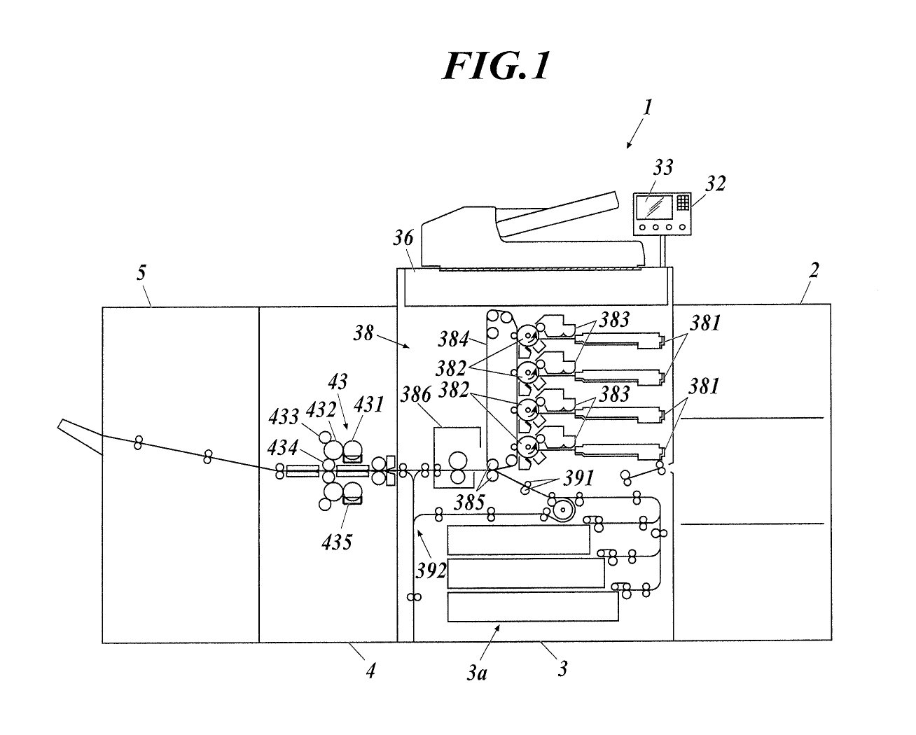

FIG. 1 illustrates the overall configuration of an image forming system 1 according to an embodiment of the present invention.

The image forming system 1 includes a sheet feeder 2, an image forming device 3, a first sheet processor 4, and a second sheet processor 5.

The sheet feeder 2 includes a plurality of large-volume sheet storage units that store multiple sheets (paper sheets). The sheet feeder 2 conveys the sheets from the storage units to the image forming device 3 in response to instructions from the image forming device 3.

The image forming device 3 forms electrophotographic images on the sheets. The image forming device 3 conveys a sheet on which an image is formed to the first sheet processor 4.

The first sheet processor 4 moisturizes the sheet from the image forming device 3 as described below. The first sheet processor 4 conveys the moisturized sheet to the second sheet processor 5.

The second sheet processor 5 carries out a predetermined process on the sheet from the first sheet processor 4 and ejects the processed sheet. Such processes include decurling, stapling, punching, folding, and binding, for example.

The sheet feeder 2, the image forming device 3, the first sheet processor 4, and the second sheet processor 5 are each detachable from a neighboring device.

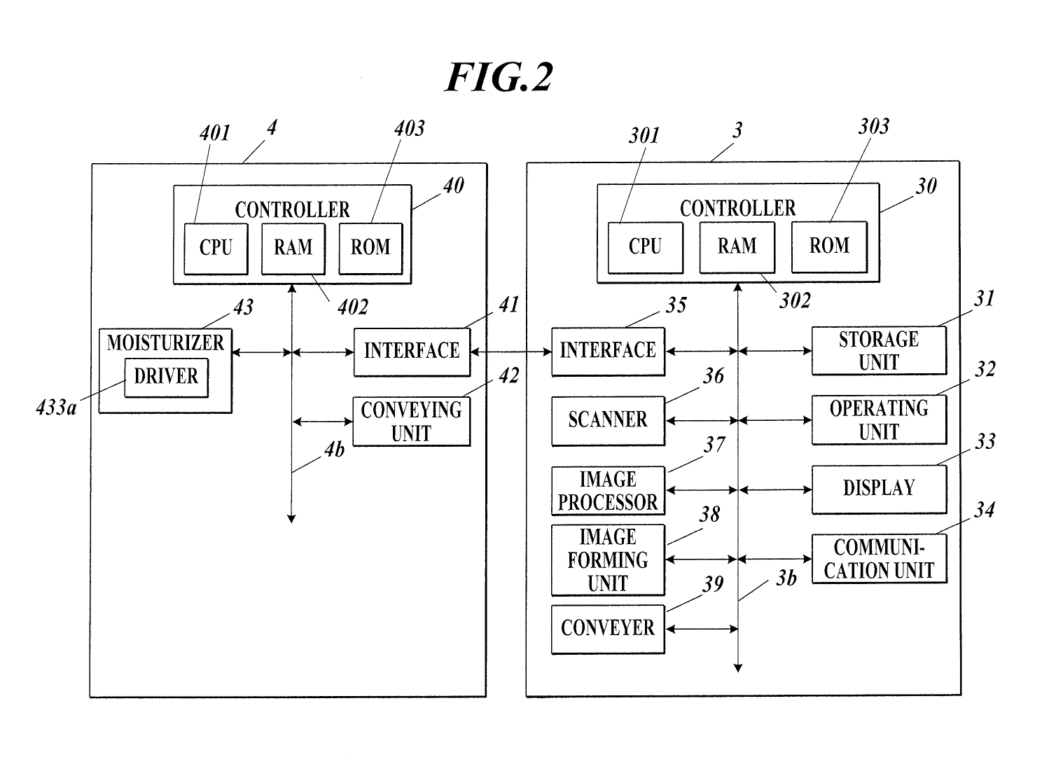

FIG. 2 is a block diagram illustrating the essential components of the image forming device 3 and the first sheet processor 4.

The image forming device 3 includes a controller 30 including a central processing unit (CPU) 301, a random access memory (RAM) 302, and a read only memory (ROM) 303, a storage unit 31, an operating unit 32, a display unit 33, a communication unit 34, an interface 35, a scanner 36, an image processor 37, an image forming unit 38, and a conveyer 39. The controller 30 is connected to the storage unit 31, the operating unit 32, the display unit 33, the communication unit 34, the interface 35, the scanner 36, the image processor 37, the image forming unit 38, and the conveyer 39 via a bus 3b.

The CPU 301 reads and executes control programs stored in the ROM 303 or the storage unit 31 and carries out various calculation processes.

The RAM 302 provides a work space for the CPU 301 and temporarily stores data.

The ROM 303 stores various control programs executed by the CPU 301 and configuration data. The ROM 303 may be replaced with a rewritable non-volatile memory, such as an electrically erasable programmable read only memory (EEPROM) or a flash memory.

The controller 30, which includes the CPU 301, the RAM 302, and the ROM 303, comprehensively controls the components of the image forming device 3 in accordance with the various control programs. For example, the controller 30 instructs the image processor 37 to carry out predetermined image processing on image data and store the processed image data in the storage unit 31. The controller 30 instructs the conveyer 39 to convey sheets and the image forming unit 38 to form images on the sheets in accordance with the image data stored in the storage unit 31.

The storage unit 31 is provided with a dynamic random access memory (DRAM), for example, to store image data acquired by the scanner 36 and image data received from external units via the communication unit 34. The image data may be stored in the RAM 302.

The operating unit 32 includes input devices, such as operating keys and a touch panel disposed on the screen of the display unit 33. The operating unit 32 converts the operation of the input devices to operation signals and sends the operation signals to the controller 30.

The display unit 33 includes a display device such as a liquid crystal display (LCD), for example, and displays the status of the image forming system 1 and an operating menu representing the content of the input to the touch panel.

The communication unit 34 establishes transmission and reception of image data with computers and other image forming devices in the network in accordance with control signals from the controller 30.

The interface 35, which is a serial interface, for example, transmits and receives data to and from the first sheet processor 4.

The scanner 36 reads the image formed on a sheet, generates image data containing monochrome image data corresponding to the color components of red (R), green (G), and blue (B), and the image data is stored in the storage unit 31.

The image processor 37 includes a rasterizer, a color converter, a gradation corrector, and a halftone processor. The image processor 37 carries out various types of image processing on the image data stored in the storage unit 31 and stores the processed image data in the storage unit 31.

The rasterizer converts vector image data that is written in predetermined page description language (PDL) and sent from a computer in the network, to raster image data, such as a bitmap The image data converted by the rasterizer contains monochrome image data for the color components of cyan (C), magenta (M), yellow (Y), and black (K).

The color converter converts the image data for the colors RGB sent from the scanner 36 with reference to a predetermined lookup table and generates image data containing the monochrome image data of the colors CMYK. The color converter also carries out predetermined color correction on the image data.

The gradation corrector corrects the gradation of the image data to achieve predetermined gradation characteristics in an image corresponding to the image data with reference to a lookup table containing correction values corresponding to gradation values.

The halftone processor carries out halftone processes, including screening with a dithering matrix and error diffusion, on the image data.

The functions of the rasterizer, the color converter, the gradation corrector, and the halftone processor in the image processor 37 may entirely or partially be performed by the controller 30 or another external image processor provided for the image forming device 3.

The image forming unit 38 forms an image on a sheet in accordance with the image data stored in the storage unit 31. The image forming unit 38 includes four sets of an exposure unit 381, a photoreceptor 382, and a developing unit 383 for the respective CMYK color components. The image forming unit 38 includes a transfer unit 384, a secondary transfer roller 385, and a fixing unit 386.

The exposure unit 381 includes a light-emitting element or laser diode (LD). The exposure unit 381 drives the LD in accordance with the image data and exposes the charged photoreceptor 382 with a laser beam to form an electrostatic latent image on the photoreceptor 382. The developing unit 383 feeds toner (colorant) of a predetermined color (one of the CMYK colors) to the exposed photoreceptor 382 from a charged developing roller to develop the electrostatic latent image on the photoreceptor 382.

Monochrome images formed of toner of the CMYK colors, respectively, on the respective photoreceptors 382 for the CMYK colors are sequentially transferred from the photoreceptors 382 onto the same area of the transfer unit 384. This forms a color image having the CMYK color components on the transfer unit 384. The transfer unit 384 is composed of an endless belt wound around multiple transfer-unit conveying rollers and rotates together with the transfer-unit conveying rollers.

The secondary transfer roller 385 transfers the color image on the transfer unit 384 to a sheet fed from the sheet feeder 2 or the sheet tray 3a. Specifically, a predetermined transfer voltage is applied to the secondary transfer roller 385 supporting the sheet and the transfer unit 384, such that the toner of the color image formed on the transfer unit 384 is attracted and transferred to the sheet.

The fixing unit 386 applies heat and pressure to the sheet on which the toner is transferred, to fix the toner to the sheet. The fixing unit 386 includes a heating roller and a pressing roller, which hold the sheet. The heating roller is heated to a predetermined temperature (for example, within the range of 180° C. to 200° C.) by a heat source or heater. The pressing roller is urged toward the heating roller with a resilient member (not shown). The sheet having the toner image transferred by the secondary transfer roller 385 travels through a nip between the heating roller and the pressing roller to fix the toner image to the sheet.

The conveyer 39 includes multiple sheet-conveying rollers that rotate to convey sheets through the nips therebetween and conveys the sheets through a predetermined conveying path. The conveyer 39 includes a register roller 391 disposed in the upstream of the secondary transfer roller 385 in the conveying direction. The register roller 391 temporarily stops the conveying of a sheet and controls the timing of feeding of the sheet to the secondary transfer roller 385. The conveyer 39 further includes an inverting mechanism 392 that turns over the sheet having an image fixed by the fixing unit 386 and conveys the turned over sheet to the secondary transfer roller 385. The inverting mechanism 392 turns over the sheet for double-sided printing by the image forming device 3. For single-sided printing, the sheet is conveyed to the first sheet processor 4 without turning over by the inverting mechanism 392.

The first sheet processor 4 includes a controller 40 including a CPU 401, a RAM 402, and a ROM 403, an interface 41, a conveying unit 42, and a moisturizer 43. The controller 40 is connected to the interface 41, the conveying unit 42, and the moisturizer 43 via a bus 4b.

The CPU 401 reads and executes control programs stored in the ROM 403 and carries out various calculation processes.

The RAM 402 provides a work space for the CPU 401 and temporarily stores data. The temporarily stored data contains, for example, set values for the moisturizing process described below.

The ROM 403 stores various control programs executed by the CPU 401 and configuration data. The ROM 403 may be replaced with a rewritable non-volatile memory, such as an EEPROM or a flash memory. The configuration data contains, for example, a lookup table for determining the moisture level of a sheet during the moisturizing process described below.

The controller 40, which includes the CPU 401, the RAM 402, and the ROM 403, comprehensively controls the components of the first sheet processor 4 in accordance with the various control programs. For example, the controller 40 instructs the moisturizer 43 to moisturize a sheet under the conditions represented by the set values stored in the RAM 402.

The interface 41 establishes transmission and reception Of data with the image forming device 3 and is a serial interface, for example.

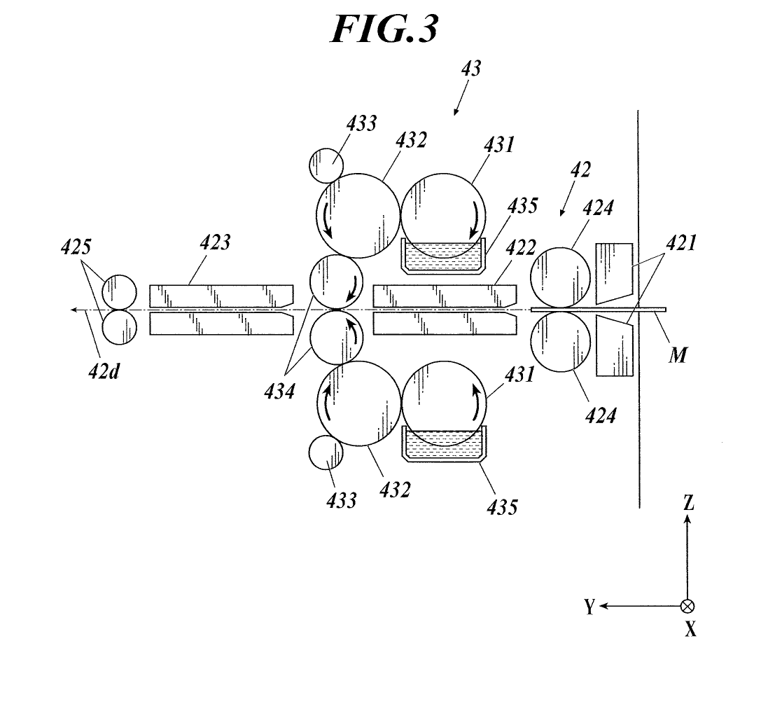

FIG. 3 is a schematic view illustrating the configurations of the conveying unit 42 and the moisturizer 43.

The conveying unit 42 includes guides 421, 422, and 423 that guide a sheet M and sheet-conveying rollers 424 and 425 that rotate to convey the sheet M therebetween, and conveys sheets through a conveying path 42d. In FIG. 3, the Y direction indicates the direction of the conveying path 42d (conveying direction).

The moisturizer 43 includes two first water feeding rollers 431 vertically disposed across the conveying path 42d, two second water feeding rollers 432 in contact with the circumferential surfaces of the respective first water feeding rollers 431, two blade rollers (water removers) 433 disposed in the vicinity of the circumferential surfaces of the respective second water feeding rollers 432, two moisturizing rollers 434 (conveying rollers) that are in contact with the circumferential surfaces of the respective second water feeding rollers 432 and hold the sheet M, and two water containers 435 that feed water to the respective first water feeding rollers 431.

The first water feeding rollers 431, the second water feeding rollers 432, and the moisturizing rollers 434 are composed of columnar members having rotary shafts extending in the X direction and circumferential surfaces having identical widths in the X direction.

The nip pressure between the first water feeding rollers 431 and the respective second water feeding rollers 432 and the nip pressure between the second water feeding rollers 432 and the respective moisturizing rollers 434 are maintained at respective predetermined constant values during the moisturizing process.

The nip pressure may be varied appropriately in response to the operation of the operating unit 32 by a user.

The first water feeding rollers 431, the second water feeding rollers 432, and the moisturizing rollers 434 can retain water on their circumferential surfaces. The circumferential surfaces are composed of a material that holds water, such as hydrophilic resin (for example, NBR).

The first water feeding rollers 431 are disposed such that the circumferential surfaces are partially immersed into water in the respective water containers 435. The circumferential surfaces of the first water feeding rollers 431 are in contact with the circumferential surfaces of the respective second water feeding rollers 432. The first water feeding rollers 431 rotate around rotary shafts to soak up the water in the respective water containers 435, retain the water on the circumferential surface, and feed the water to the circumferential surfaces of the respective second water feeding rollers 432.

The circumferential surfaces of the second water feeding rollers 432 are in contract with the circumferential surfaces of the respective first water feeding rollers 431 and the circumferential surfaces of the respective moisturizing rollers 434. The second water feeding rollers 432 rotate together with the moisturizing rollers 434 to feed the water fed from the circumferential surfaces of the first water feeding rollers 431 to the circumferential surfaces of the respective moisturizing rollers 434.

The blade rollers 433 are disposed in the vicinity of the respective second water feeding rollers 432 with predetermined gaps between the circumferential surfaces of the blade rollers 433 and the circumferential surfaces of the respective second water feeding rollers 432.

The blade rollers 433, similar to the second water feeding rollers 432, are composed of columnar members rotating around rotary shafts extending in the X direction. The width of the circumferential surfaces of the blade rollers 433 in the X direction is larger than or equal to that of the second water feeding rollers 432.

The circumferential surfaces of the blade rollers 433 move relative to (or rotate in the opposite direction to) the circumferential surfaces of the respective second water feeding rollers 432 to remove excess water retained on the circumferential surfaces of the second water feeding rollers 432.

The moisture level of the second water feeding rollers 432 can be adjusted by varying the distances between the circumferential surfaces of the blade rollers 433 and the circumferential surfaces of the respective second water feeding rollers 432 through drive control by the drivers 433a.

The drivers 433a are provided to respectively drive two blade rollers 433 independently.

The blade rollers 433 are composed of a water-resistant material that hardly absorbs water, to effectively remove excess water retained on the circumferential surfaces of the respective second water feeding rollers 432. For example, resin such as polypropylene is preferred for its water resistant and non-absorbing properties and insensitivity to the adhesive contained in the sheets.

The blade rollers 433 preferably have smooth surfaces to uniformly remove water retained on the circumferential surfaces of the respective second water feeding rollers 432.

The blade rollers 433 may have any configuration for removing water from the second water feeding rollers 432; for example, the blade rollers 433 may rotate in the direction opposite to the rotation of the second water feeding rollers 432 or may not rotate at all.

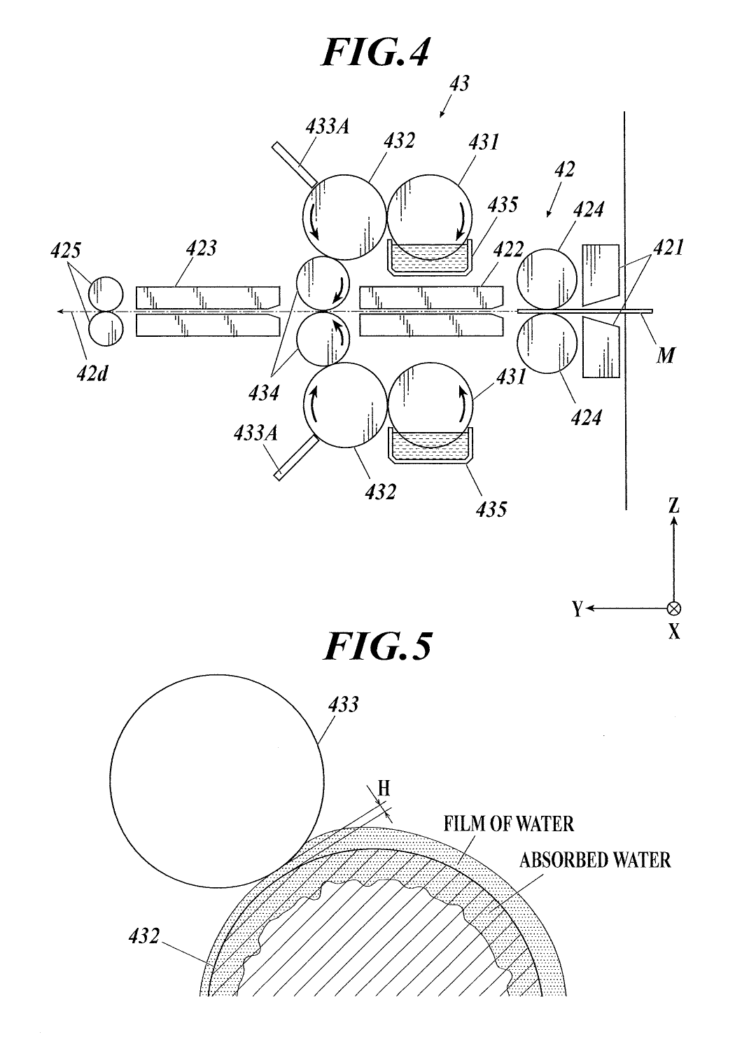

The water removers described above are composed of rollers (blade rollers 433). Besides the rollers, the water removers for removing water from the second water feeding rollers 432 may be composed of plates 433A extending in the width direction (X direction) of the sheet, as illustrated in FIG. 4.

Water feeding mechanisms each including a water container 435, a first water feeding roller 431, a second water feeding roller 432, and a blade roller 433 are disposed on the +Z and −Z directions relative to the conveying path 42d, as illustrated in FIG. 3.

Water is fed from the water feeding mechanism on the +Z side to the moisturizing roller 434 on the +Z side and from the water feeding mechanism on the −Z side to the moisturizing roller 434 on the −Z side.

The circumferential surfaces of the moisturizing rollers 434 have a width along the X direction that is larger than the width of the sheet M in the X direction. The moisturizing rollers 434 function as conveying rollers that hold the sheet M that has traveled along the guides 422 and rotate while the sheet M is held to convey the sheet M. The moisturizing rollers 434 convey the sheet M and moisturize the sheet M with the water retained on the circumferential surfaces of the moisturizing rollers 434.

The moisturizing process will now be described which is carried out by the first sheet processor 4 of the image forming system 1 having the configuration described above.

The moisturizing process is carried out, for example, in response to the first sheet processor 4 receiving a sheet M after an image is formed on the sheet M by the image forming device 3.

The moisturizing process is carried out under the control of the controller 40 of the first sheet processor 4.

The moisture level of the sheet M moisturized by the moisturizing rollers 434 is determined with reference to the lookup table stored in the ROM 403 involving information on the type, basis weight, and printing conditions (e.g., single-sided or double-sided printing mode) of the sheet M.

The lookup table stored in the ROM 403 contains set values indicating the appropriate volume of water to be the fed to sheets M having different combinations of the type, basis weight, and printing conditions. The set values are preliminarily defined through determination of the moisture level required for achieving the same moisture level of the sheet M of a different type and a different basis weight under different printing conditions.

The parameters for determining the moisture level may be any one or more of the type, basis weight, and printing conditions of the sheet M. The parameters may include those other than the type, basis weight, and printing conditions of the sheet M.

In the moisturizing process carried out by the moisturizer 43 under instructions from the controller 40, the controller 40 first acquires information on the sheet conditions including the type, basis weight, and the printing condition of the sheet from the job information instructing image formation received by the image forming device 3.

The controller 40 refers to the lookup table stored in the ROM 403 involving the acquired information, acquires the set values for the moisture level, and stores the set values in the RAM 402.

The controller 40 varies the distances between the second water feeding rollers 432 and the respective blade rollers 433 in accordance with the set values, to adjust the volume of water retained on the circumferential surfaces of the second water feeding rollers 432, and control the volume of water fed from the moisturizing rollers 434 to the sheet M.

With reference to FIG. 5, the volume (supplied water amount) of water fed from the second water feeding rollers 432 is defined as follows:

supplied water amount=volume of water absorbed by second water feeding roller 432+volume of film of water on surface of corresponding second water feeding roller 432.

According to this embodiment, the controller 40 controls the distances H between the second water feeding rollers 432 and the respective corresponding blade rollers 433, as described above. That is, the controller 40 controls the thickness of the films of water on the surfaces of the water feeding rollers 432.

The thickness of the films of water on the surfaces of the second water feeding rollers 432 stabilizes after the respective blade rollers 433 pass through. Thus, water can be stably fed to the moisturizing rollers 434 to achieve stable moisturizing of the sheet conveyed between the moisturizing rollers 434.

The distance H is determined such that the volume of the films of water on the surfaces of the second water feeding rollers 432 after the respective blade rollers 433 pass through is less than or equal to the maximum volume of water that can be retained on the corresponding moisturizing rollers 434.

Specifically, the controller 40 increases the distance between the second water feeding rollers 432 and the respective blade rollers 433 for sheets having a large thickness or basis weight. Such a sheet is moisturized with a large volume of water because sheets having a large thickness or basis weight have low permeability to water.

The controller 40 decreases the distance between the second water feeding rollers 432 and the respective blade rollers 433 for sheets having a small thickness or basis weight.

Such a sheet is moisturized with a small volume of water because sheets having a small thickness or basis weight have high permeability to water.

The controller 40 independently controls the distance between each of the second water feeding rollers 432 and the corresponding blade roller 433.

Specifically, for single-sided coated paper, the controller 40 increases only the distance between the second water feeding roller 432 and the corresponding blade roller 433 on the side of the coated face. This moisturizes only the coated face with a large volume of water to compensate for the low permeability to water of the coated side.

As described in the embodiments above, the first sheet processor 4 includes moisturizing rollers 434 that moisturize a sheet; second water feeding rollers 432 that feed water to the circumferential surfaces of the respective moisturizing rollers 434; blade rollers 433 disposed in the vicinity of the respective second water feeding rollers 432 and adjust the volume of the water retained on the circumferential surfaces of the respective second water feeding rollers 432; and a controller 40 that controls the distance between the second water feeding rollers 432 and the respective blade rollers 433.

The thickness of the films of water on the circumferential surfaces of the second water feeding rollers 432 is controlled to adjust the volume of water. This stabilizes the water fed from the second water feeding rollers 432 to the respective moisturizing rollers 434, and achieves desired neutralization.

According to this embodiment, the first sheet processor 4 includes two moisturizing rollers 434 in contact with each other at the circumferential surfaces; two second water feeding rollers 432 provided on the respective moisturizing rollers 434; and two blade rollers 433 respectively provided for the second water feeding rollers 432, wherein a controller 40 independently controls the distance between each of the second water feeding rollers 432 and the corresponding blade roller 433.

In this way, the two sides of a sheet can be appropriately moisturized by different volumes of fed water to the two sides of the sheet.

According to this embodiment, the moisturizing rollers 434 of the first sheet processor 4 hold and convey sheets.

In other words, the moisturizing rollers 434 function as both moisturizing rollers 434 and conveying rollers. This simplifies the configuration of the sheet processor.

According to this embodiment, the controller 40 controls the distances between the rollers in accordance with the sheet conditions including the type and printing conditions of the sheet.

In this way, the sheets can be appropriately moisturized by feeding appropriate volumes of water to the sheets depending on the sheet conditions.

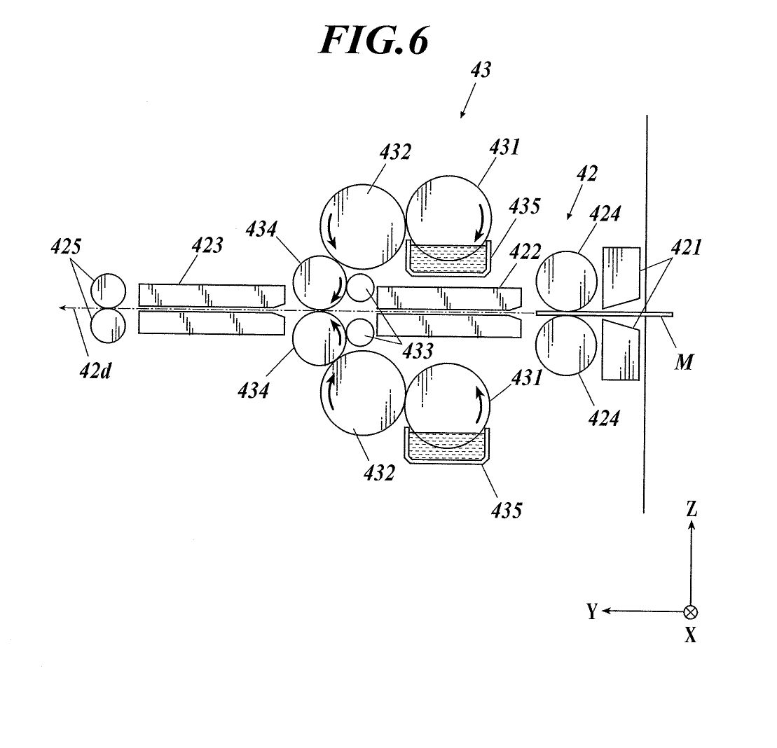

According to this embodiment, the blade rollers 433 are disposed in the vicinity of the respective second water feeding rollers 432 to adjust the volume of water retained on the circumferential surfaces of the respective second water feeding rollers 432. Alternatively, the blade rollers 433 may be disposed in the vicinity of the respective moisturizing rollers 434 to adjust the volume of water retained on the circumferential surfaces of the respective moisturizing rollers 434, as illustrated in FIG. 6.

In such a configuration, the water fed from the circumferential surfaces of the second water feeding rollers 432 to the circumferential surfaces of the respective moisturizing rollers 434 is removed by the blade rollers 433 from the circumferential surfaces of the moisturizing rollers 434. This adjusts the thickness of the films of water on the circumferential surfaces of the moisturizing rollers 434. Thus, similarly to the embodiments described above, water can be stably fed to the sheet to achieve desired neutralization.

In such a configuration, it is preferred that the controller 40 independently controls the distance between each of the moisturizing rollers 434 and the corresponding blade roller 433. In this way, the two sides of a sheet can be appropriately moisturized by feeding different volumes of water to the two sides of the sheet.

In such a configuration, the blade rollers 433 can be replaced with the planar water removers illustrated in FIG. 4.

According to the embodiments described above, the distances between the rollers are controlled on the basis of the sheet conditions including the type, basis weight, and printing conditions of the sheet. Alternatively, the distance may be controlled on the basis of the installation environment of the first sheet processor 4 or the quality of the water.

For example, the distances between the rollers may be increased in a low-humidity environment.

An electrometer for measuring the surface potential may be provided to control the distances between the rollers in accordance with the measured value.

The configuration according to the embodiments described above includes first water feeding rollers 431 and second water feeding rollers 432. Alternatively, the configuration may include only one of the water feeding roller.

In the embodiments described above, a moisturizer 43 is provided in a conveying path through which a sheet is conveyed in the Y direction. Alternatively, a moisturizer 43 may be provided in the conveying path through which a sheet is conveyed in the Z direction.

Japanese Patent Application No. 2015-064412 submitted to the Japan Patent Office on Mar. 26, 2015 is hereby incorporated by reference in its entirety.

What is claimed is:

1. A sheet processor comprising:
at least one moisturizing roller that moisturizes a sheet;
at least one water feeding roller that feeds water to a circumferential surface of the moisturizing roller;
at least one water remover that is disposed in the vicinity of the water feeding roller and adjusts the volume of the water retained on a circumferential surface of the water feeding roller; and
a controller that controls a distance between the water feeding roller and the water remover.

2. A sheet processor comprising:
at least one moisturizing roller that moisturizes a sheet;
at least one water feeding roller that feeds water to a circumferential surface of the moisturizing roller;
at least one water remover that is disposed in the vicinity of the moisturizing roller and adjusts the volume of the water retained on the circumferential surface of the moisturizing roller; and
a controller that controls a distance between the moisturizing roller and the water remover.

3. The sheet processor according to claim 1, wherein:
the at least one moisturizing roller comprises one and another moisturizing rollers that have circumferential surfaces in contact with each other;
the at least one water feeding roller comprises one and another water feeding rollers respectively provided for the one and another moisturizing rollers; and
the at least one water remover comprises one and another water removers respectively provided for the one and another water feeding rollers,
wherein the controller independently controls the distance between the one water feeding roller and the one water remover and the distance between the another water feeding roller and the another water remover.

4. The sheet processor according to claim 2, wherein:
the at least one moisturizing roller comprises one and another moisturizing rollers that have circumferential surfaces in contact with each other;
the at least one water feeding roller comprises one and another water feeding rollers respectively provided for the one and another moisturizing rollers; and
the at least one water remover comprises one and another water removers respectively provided for the one and another moisturizing rollers,
wherein the controller independently controls the distance between the one moisturizing roller and the one water remover and the distance between the another moisturizing roller and the another water remover.

5. The sheet processor according to claim 3, wherein the one and another moisturizing rollers hold and convey the sheet.

6. The sheet processor according to claim 4, wherein the one and another moisturizing rollers hold and convey the sheet.

7. The sheet processor according to claim 1, wherein the controller controls the distance based on sheet conditions including a type and printing conditions of the sheet.

8. The sheet processor according to claim 2, wherein the controller controls the distance based on sheet conditions including a type and printing conditions of the sheet.

9. The sheet processor according to claim 1, wherein the controller controls the distance based on an installation environment of the sheet processor and a quality of the water.

10. The sheet processor according to claim 2, wherein the controller controls the distance based on an installation environment of the sheet processor and a quality of the water.

11. An image forming system, comprising:
an image forming device that forms an image on a sheet; and
the sheet processor according to claim 1, the sheet processor being connected to the image forming device and moisturizing the sheet having an image formed by the image forming device.

12. The image forming system comprising:
an image forming device that forms an image on a sheet; and
the sheet processor according to claim 2, the sheet processor being connected to the image forming device and moisturizing the sheet having an image formed by the image forming device.
